(19) United States
(12) Patent Application Publication
(10) Pub. No.: US 2010/0289370 A1
(43) Pub. Date: Nov. 18, 2010

(54) SYNCHRONOUS MOTOR HAVING 12 STATOR TEETH AND 10 ROTOR POLES

(75) Inventors: Karl-Juergen Roth, Schwieberdingen (DE); Kurt Reutlinger, Stuttgart (DE)

Correspondence Address: MERCHANT & GOULD PC, P.O. BOX 2903, MINNEAPOLIS, MN, 55402-0903, US

(73) Assignee: Robert Bosch GMBH, Stuttgart (DE)

(21) Appl. No.: 12/665,877

(22) PCT Filed: Apr. 28, 2008
(86) PCT No.: PCT/EP2008/055178

§ 371 Date: Jun. 2, 2010

(30) Foreign Application Priority Data
Jun. 25, 2007 (DE) 10 2007 029 157.6

(51) Int. Cl. H02K 1/27; H02K 1/22; H02K 3/28

(52) U.S. Cl. 310/156.53; 310/216.092; 310/195

(57) ABSTRACT

The invention relates to an electric machine (1), in particular a synchronous machine, comprising a stator arrangement (3) having twelve stator teeth (2) and a rotor (6) having ten rotor poles (4). Said rotor poles (4) are separated by air gaps (9) and the rotor poles (4) are embodied as sinus poles.

### TECHNICAL FIELD

The invention relates to a synchronous motor having 12 stator teeth and 10 rotor poles, in particular for use in electrical power steering assists.

### STATE OF THE ART

In the case of electrical drives for steering systems having electromechanical assistance, which are used in motor vehicles, it is necessary for the fluctuations in the drive torque produced at the shaft to be very small. Electrically commutated permanent magnet synchronous motors are normally used as such drives because they are preferred for these applications on account of their power density, their level of efficiency and their control options. So-called harmonic torques, which can lead to considerable fluctuations in the torque, arise, however, as a result of harmonics in electrically commutated synchronous motors. Therefore, such drives have to be embodied in such a way that these harmonics are reduced as much as possible or that their effect on the torque curve is small.

Furthermore, fluctuations in torque occur not only under load but also when the stator winding is de-energized. In the latter case, said fluctuations are denoted as detent torques. A conventional method for reducing detent torques in synchronous motors consists of selecting the ratio of the number of stator winding slots to the pole number in such a way that the least common multiple is as large as possible. This can, for example, be achieved by a finely distributed winding (for example with q=2, respectively 2 slots per pole and phase). Due to the cramped space conditions with respect to small electrical motors, it is, however, often not possible to insert a finely distributed winding into the armature in order to produce a suitable air gap field having a small harmonic content. For that reason corresponding harmonics must be expected in the air gap particularly in the case of such synchronous motors of compact design. The harmonics should however be such that they do not generate or generate only small harmonic torques. For that reason fractional slot windings (number of slots per pole and phase) are often used in small synchronous machines. This is, for example, implemented in a synchronous motor having 9 stator teeth in the stator and 8 rotor poles, respectively having 18 stator teeth in the stator and 8 rotor poles.

A further essential requirement consists of making an electric motor more reliable. In contrast to electrically energized machines, it is not possible with permanent magnets to switch off the magnetic field. In the event of faults, as, for example short circuits in the winding, this can lead to considerable braking torques, which can lead to a blockage of the steering when applied to a steering system. For that reason it is desirable to provide electrical motors, which have a reduced probability of failure and smaller braking torques in the event of faults.

### SUMMARY

It is therefore the aim of the present invention to provide a synchronous motor, which can be constructed in a simple manner, has small detent torques and has a small torque undulation and moreover has an increased reliability due to its form of construction.

This task is solved by the synchronous machine according to claim 1.

Additional advantageous configurations of the invention are stated in the dependent claims.

According to one aspect, provision is made for an electrical machine, particularly a synchronous machine. The electrical machine comprises a stator arrangement having twelve stator teeth as well as a rotor having ten rotor poles, the rotor poles being separated by air gaps and said rotor poles being embodied as sinus poles.

The embodiment of an electrical machine having twelve stator teeth and ten rotor poles in combination with the embodiment of the rotor poles has the advantage that the detent torque and the harmonic torques can be significantly reduced compared to an electrical machine without sinus poles.

The tangential air gaps between the poles expand outwardly in a radial direction.

According to an additional embodiment, each rotor pole is provided with a permanent magnet, whose north pole to south pole direction extends radially, the polarity of permanent magnets adjacent to each other being opposite.

The rotor poles can furthermore be embodied in a consequent-pole arrangement, only every other rotor pole being configured with a permanent magnet, whose north to south pole direction extends radially, the polarity of the permanent magnets being rectified.

According to another embodiment, provision is made for permanent magnets, whose north to south pole direction extends in a circumferential direction, to be arranged inside of the rotor, particularly in pockets. Particularly permanent magnets arranged adjacent to each other can have a poling direction, which is opposite to one another.

A pocket for accommodating one of the permanent magnets can furthermore be provided between in each case two rotor poles, only every other pocket being provided with a respective permanent magnet.

The stator teeth can be wound according to a consequent-tooth arrangement, only every other stator tooth bearing a stator coil.

Each stator tooth can furthermore be provided with a stator coil, provision being made for the stator coils to be arranged in groups having in each case two stator coils connected in series. The groups of stator coils are then connected up in a star circuit or in a plurality of said circuits. The groups of stator coils can particularly be connected up in two star circuits having in each case three groups of stator coils, the corresponding three groups of stator coils being connected to connections for three phase voltages.

Alternatively each stator tooth can be provided with a stator coil, provision being made for the stator coils to be arranged in groups having in each case two stator coils connected in series, wherein the groups of stator coils are connected up in a delta connection or in a plurality of said connections. The groups of stator coils can particularly be connected up in two delta connections having in each case three groups of stator coils, the corresponding three groups of stator coils respectively of one of the delta connections being connected to connections for three phase voltages.

### SHORT DESCRIPTION OF THE DRAWINGS

Preferred embodiments of the present invention are subsequently explained in detail using the accompanying drawings. The following are shown:

FIG. 1 a cross-sectional depiction of a 12/10 synchronous motor according to a first embodiment of the invention;

FIG. 2 a cross-sectional depiction of a rotor of a 12/10 synchronous motor according to an additional embodiment of the invention;

FIG. 3 a cross-sectional depiction of a rotor of a 12/10 synchronous motor according to an additional embodiment of the invention;

FIG. 4 a cross-sectional depiction of a rotor of a 12/10 synchronous motor according to an additional embodiment of the invention;

FIG. 5 a cross-sectional depiction of a rotor of a 12/10 synchronous motor according to an additional embodiment of the invention;

FIG. 6 a cross-sectional depiction of a stator arrangement according to an additional embodiment;

FIGS. 7 to 12 show different options for the circuitry of the stator coils of the 12/10 synchronous motor according to the embodiments listed above.

### DETAILED DESCRIPTION

Like reference numerals correspond to elements of the same or a comparable function in the following embodiments.

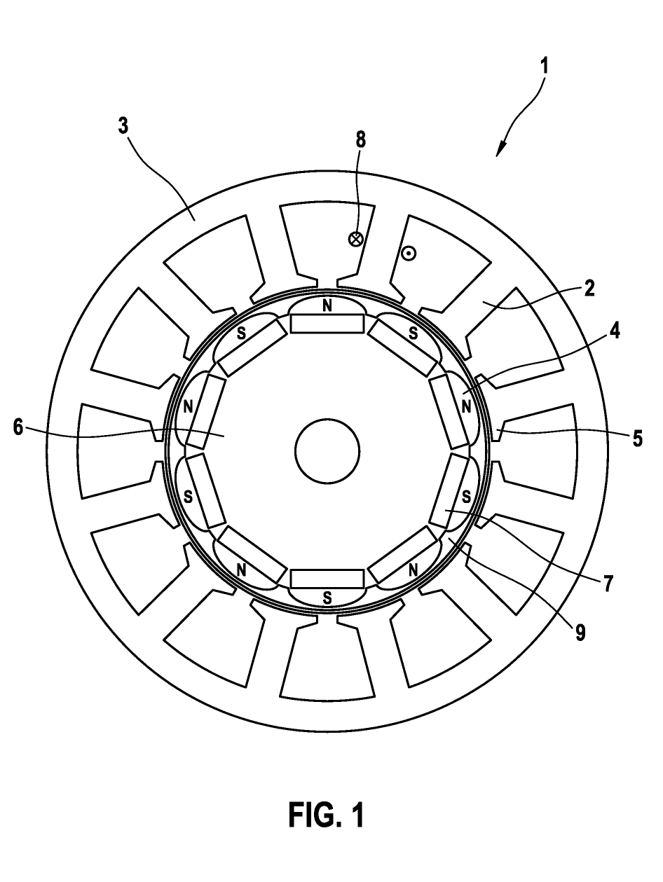

FIG. 1 shows a cross section through a synchronous motor 1 according to an embodiment of the invention. The synchronous motor 1 is constructed having 12 stator teeth 2 and 10 rotor poles 4 and is subsequently referred to as a 12/10 synchronous motor. The stator teeth 2 are arranged on a stator 3 so that their respective tooth tips 5 point to a common center, their respective central axes extending in a radial direction around a center, which preferably surrounds the ring-shaped stator 2. The stator teeth 2 are furthermore evenly arranged, i.e. equidistantly spaced apart from each other (angular offset), inside the stator 3. A rotor 6 is furthermore situated inside the stator 3, whose axis of rotation preferably corresponds to the center. 10 pole magnets 7 (permanent magnets), whose pole directions extend substantially in a radial direction to the rotor 6, are evenly distributed around the periphery of the rotor 6. Pole magnets 7, which are situated adjacent to one another, are of opposite polarity to one another with respect to the radial direction. In so doing, two rectified pole magnets face each other in each case with respect to the rotor axis.

The stator teeth 2 are surrounded by stator coils 8, which in each case enclose a stator tooth 2 in the example of embodiment shown. (In the example of embodiment shown only one stator coil is depicted for the sake of clarity.) In contrast to known embodiments from the technical field, this has the advantage in that winding strands, which run in a crosswise direction, can be avoided in the case of stator coils 8, which enclose two or more stator teeth 2. In so doing, the probability of short circuits can be reduced and therefore the reliability of the system can be increased. Only one stator coil 8 is depicted in FIG. 1 for the sake of clarity.

The pole magnets 7 of the rotor 6 are embedded in the rotor 6, i.e. are configured as so-called buried magnets. An external peripheral surface of the rotor 6, which is substantially cylinder-shaped, is provided with rotor poles and with air gaps 9 between the rotor poles 4, which starting from a web limiting the depth of the air gap outwardly expand in a radial direction in order to form so-called sinus poles. Sinus poles are magnet poles of an electric motor, whereat a sinus-shaped air induction arises. Such sinus poles are, for example, already described by Rudolf Richter in “Electric Machines”, volume 1, page 170ff, Julius Springer publisher: 1924. Because the contour in the pole gap, i.e. in the air gap between the poles, can not follow the exact equation, this region between the permanent magnets 6 is to be configured according to mechanical criteria. For this reason, the contour, which is predetermined by the sinus pole design, is continued only up until a certain width beyond the respective rotor pole 4. The gap is implemented only up until a certain depth between the poles because it does not have a large effect on the air gap field in this region. Said gap is configured according to mechanical criteria in this region

In the case of buried permanent magnets, the air-gap widening leads to the material of the rotor 6 being more strongly curved across its pole in a radial direction outside of the permanent magnets than the peripheral line of the external radius of the rotor 6. Expanding air gaps are thus formed between the poles 4 of the rotor 6. This contour for the air gap produces an air gap field, which is approximately sinusoidal due to the magnet wheel, whereby a significant reduction in the detent torques at engine idle and in the harmonic torques under load is made possible. An approximation function is preferably used for the contour of the air-gap widening, which can be indicated by 1/cos(P·φ). P corresponds to the number of pole pairs and φ to the spatial angle starting from a centerline of the pole 4. (A more exact depiction of this approximation equation appears in the publication of the German patent DE 103 14 763.)

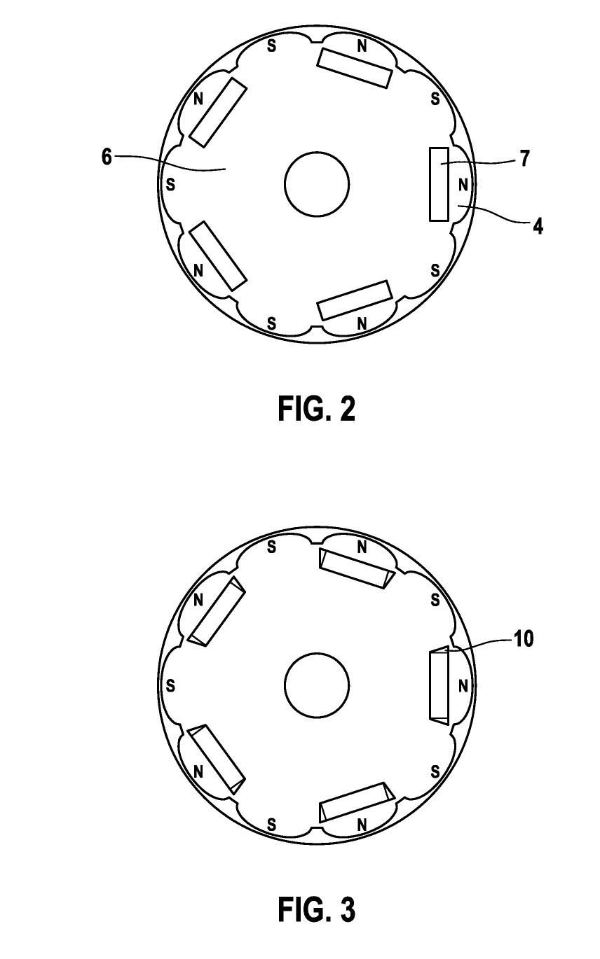

FIG. 2 shows a cross-sectional representation of a rotor 6 for a synchronous motor according to an additional embodiment of the invention. The rotor 6 is configured in a consequent-pole arrangement and has only five rectified permanent magnets 7, only every other rotor pole 4 being provided with a permanent magnet 7. The rotor poles 4, whereat no permanent magnets 7 are provided, are formed by the adjacent rectified permanent magnets 7 due to the magnetic yoke through the material of the rotor 6. In the case of the synchronous motor of FIG. 2, this leads to a rotor arrangement with five main poles and five consequent poles. Such a consequent-pole arrangement can be advantageously used in a 12/10 synchronous motor because such a synchronous motor does not produce any subharmonic stator waves of the magnitude of one-half (½=0.5) (wave length=twice the rotor fundamental wave=four times the pole pitch) or their odd multiples. Assembly complexity and costs can be reduced by using the option of a consequent-pole arrangement, in particular in the case of structurally small motors. The costs of relatively expensive permanent magnets can also be saved at the same time.

A cross-sectional depiction of a rotor for a synchronous motor according to a further embodiment of the invention is depicted in the embodiment of FIG. 3. The permanent magnets 6 are thereby arranged in trapezoidal pockets 10, whereby the effects of the lines of force of the main poles can be reduced by the lines of force of the adjacent consequent poles. The trapezoidal pockets 10 are configured to taper inwardly in a radial direction. The inserted permanent magnet 7 is, for example, configured in a parallelepiped fashion or in the shape of a loaf of bread in order that there is clearance between the wall of a respective trapezoidal pocket 10 and the corresponding permanent magnet 7. Said clearance allows for the returning magnetic flux to be led past the permanent magnet at a certain distance. Conversely the pocket can expand toward the inside. It is thereby possible to move the pockets into the pole further to the outside and to place the magnet closer to the air gap.

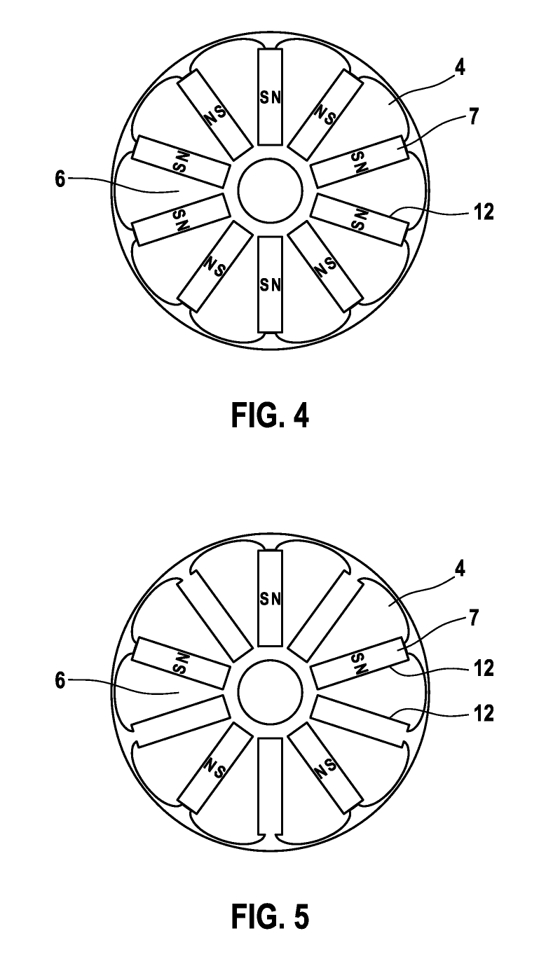

A further embodiment of a rotor arrangement with positioned magnets is depicted in FIG. 4. Contrary to arranging the permanent magnets so that the north and south pole of a permanent magnet 7 extend in a radial direction, FIG. 4 shows an embodiment, wherein the permanent magnets 7 are configured as so-called spoke magnets, whose magnetic poles are arranged in the circumferential direction. Pole magnets facing each other correspond to like poles. The permanent magnets 7 are arranged in positioned pockets 12. The lines of force are led to the outside by the rotor material arranged between the positioned permanent magnets 7. In so doing, this likewise leads to a sinusoidal air gap field with the previously described advantage in a segment between two adjacently positioned permanent magnets 7 as a result of the exterior surface of the rotor 6 being formed corresponding to a sinus pole. An arrangement of the permanent magnets 7 as spoke magnets allows for an increase in the torque density and the pole flux of the synchronous motor. The magnetic flux can be concentrated from the permanent magnets 7 up to the rotor pole 4 of the rotor 6 by means of the arrangement as spoke magnets 7; and a larger pole flux can be generated across the air gap. It is thereby possible to generate a larger torque with the same installation size and number of permanent magnets 7.

FIG. 5 shows a consequent-pole arrangement using spoke magnets 7, a spoke permanent magnet 7 being arranged only in every other pocket 12 of the rotor 6 while the pockets 12 lying between them remain empty. A consequent-pole arrangement is also possible in the spoke arrangement of the permanent magnets 7. Although no main poles and consequent poles are thereby formed, the rotor poles 4 substantially bring about an identical course of the line of force. In order to increase the mechanical stability of such a rotor 6, it can be useful to fill the pockets 12 not fitted with spoke magnets 7 with magnetic and non-active material. These empty pockets 14 can furthermore be used for additional constructive elements.

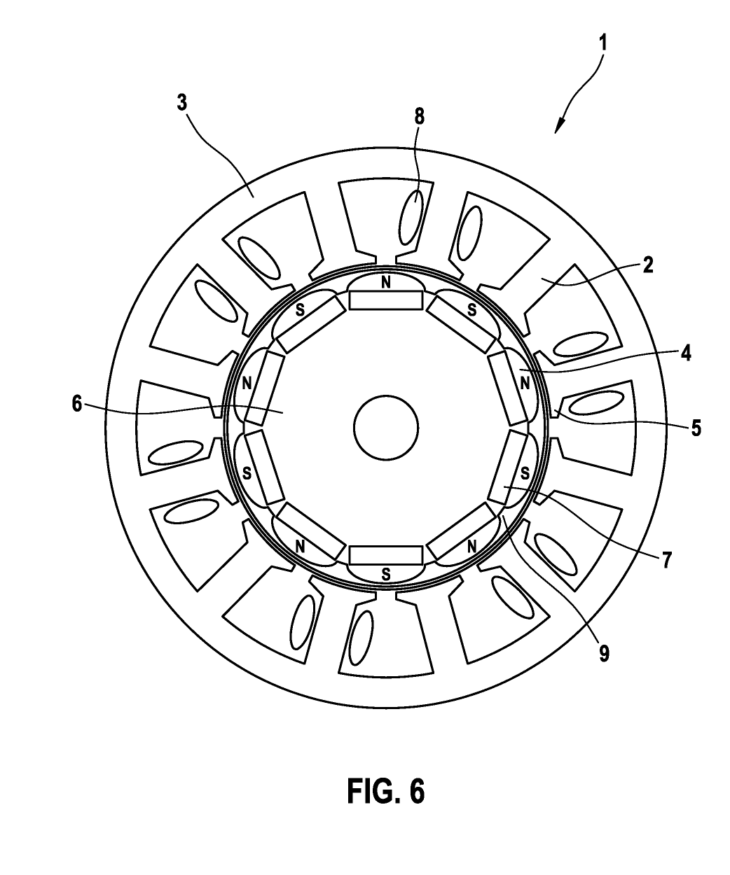

A stator arrangement of a synchronous motor is shown in FIG. 6, wherein every other stator tooth 2 is not wound so that only six stator coils 8 have to be provided. Such an arrangement is known according to the previously described consequent-pole arrangement as a consequent-tooth arrangement, the stator teeth 2, which are not wound, configuring a fully functional stator tooth 2 by means of the magnetic yoke. Such a stator arrangement can be used with each of the rotor arrangements previously described.

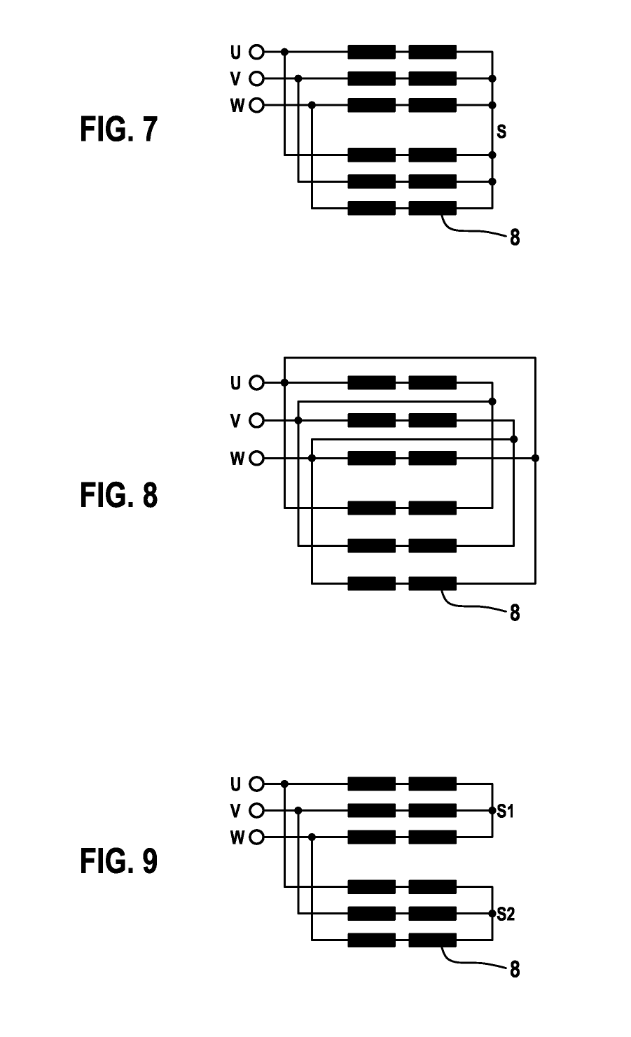

Different embodiments of the electrical circuitry of the stator coils 8 of the embodiments of FIGS. 1 to 5 are depicted in the FIGS. 7 to 12. Two stator coils 8 are thereby in each case connected to each other in series, preferably two stator coils 8 facing each other in the stator. In each case, two stator coils 8 connected to each other in series bring about an opposite magnetic flux with respect to the radial direction during activation. That means if the flux direction of one of the two stator coils 8 is in the direction of the rotor 6, the flux direction of the correspondingly other stator coil 8 is opposite thereto, i.e. away from the rotor 6.

The 12 stator coils therefore constitute 6 groups of in each case two diametrically opposed stator coils 8 connected in series in the stator. Said coils 8 are electrically activated via three phases U, V, W. In so doing, two groups of stator coils 8 are in each case connected to a phase. FIG. 7 shows a circuitry of the groups of the stator coils 8 in the star circuit, i.e. each of the group of the stator coils 8 is connected to one of the phases U, V, W by one connection and to an additional connection by a common star point S.

In FIG. 8 a circuitry in a delta connection is depicted, two of the groups of stator coils 8 in each case being connected in parallel with each other and the corresponding parallel circuit being connected with its two nodes to a node of another of the parallel circuits in order to form a delta connection. Each node is connected to one of the phases U, V, W.

As shown in FIG. 9, the groups of the stator coils 8 can also be connected up in a star circuit with separated star points S1, S2, wherein in each case three groups of stator coils 8 are operated via three phases and have a common star point so that two star circuits, which when connected in parallel to each other are connected to the phases U, V, W, exist side by side.

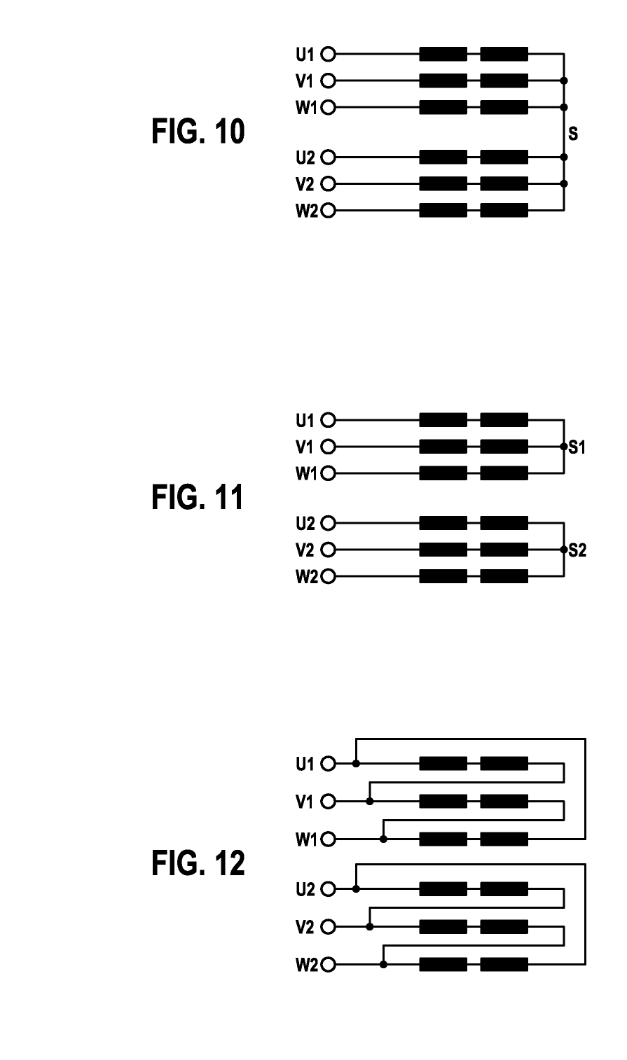

In FIGS. 10 to 12 circuitries of stator coils 8 are shown, which in each case are operated with two three-phase systems.

FIG. 10 shows a circuit with a common star point, three groups of stator coils 8 being operated in each case with separated three-phase activation voltages U1, V1, W1, respectively U2, V2, W2.

An embodiment is shown in FIG. 11, wherein three groups of stator coils 8 are configured completely independently of each other. That means that three groups of stator coils 8 are connected to each other in a star circuit via a common star point S1 and are operated by phase voltages of a first three-phase system. Furthermore, an additional star circuit S with three groups of stator coils 8 is operated via phase voltages of an additional three-phase system. It is advantageous for provision to be made for such a system to have a symmetrical construction in the stator.

Analogous to the embodiment of FIG. 11, the embodiment of FIG. 12 shows a circuitry in a delta connection, wherein two delta connections, which are to be operated independently of one another, having in each case three groups of two stator coils 8 are provided as symmetrically as possible side by side at the stator. Separating the star points into two or more star points, which are separated from one another, respectively provision being made for stator coil arrangements with separate activation, has the advantage in that the braking torque caused by a system fault, i.e. the occurrence of a short circuit and the like, can be reduced.

1. Electric machine, in particular a synchronous machine, comprising a stator arrangement having twelve stator teeth and a rotor having ten rotor poles. Said rotor poles are separated by air gaps and the rotor poles are embodied as sinus poles.

2. The electric machine according to claim 1, wherein the tangential air gaps expand outwardly in a radial direction.

3. The electric machine according to claim 1, wherein the pole contour for the sinus poles, which is formed by the rotor poles and the air gaps, is configured according to an approximation function of 1/cos(P·φ).

4. The electric machine according to claim 1, wherein each rotor pole is provided with a permanent magnet, whose north to south pole direction extends radially, the polarity of permanent magnets adjacently situated to one another being opposite.

5. The electric machine according to claim 1, wherein rotor poles are configured in a consequent-pole arrangement, only every other rotor pole being configured with a permanent magnet, whose north to south pole direction extends radially, the polarity of the permanent magnets being rectified.

6. The electric machine according to claim 1, wherein provision is made for permanent magnets, whose north to south pole direction runs in a circumferential direction, to be positioned inside of the rotor, in particular in pockets.

7. The electric machine according to claim 6, wherein permanent magnets adjacently situated to one another have a poling direction opposite to one another.

8. The electric machine according to claim 6, wherein a pocket is provided between two rotor poles for accommodating a permanent magnet, only every other pocket being provided with a permanent magnet.

9. The electric machine according to claim 1, wherein the stator teeth are wound according to a consequent tooth arrangement, only every other stator tooth bearing a stator coil.

10. The electric machine according to claim 1, wherein each stator tooth is provided with a stator coil, provision being made for the stator coils to be arranged in groups having in each case two stator coils connected in series.

11. The machine according to claim 9, wherein the groups of stator coils are connected up in one or a plurality of star circuits.

12. The electric machine according to claim 9, wherein the groups of stator coils are connected up in one of two star circuits having in each case three groups of stator coils, the corresponding three groups of stator coils being connected to connections for three phase voltages.

13. The electric machine according to claim 9, wherein the groups of stator coils are connected up in one or a plurality of delta connections.

14. The electric machine according to claim 13, wherein the groups of stator coils are connected up in two delta connections having in each case three groups of stator coils, the corresponding three groups of stator coils being connected in each case to one of the delta connections having connections for three phase voltages.
